(19) United States
(12) Patent Application Publication
(10) Pub. No.: US 2006/0281407 A1
(43) Pub. Date: Dec. 14, 2006

(54) Methods for controlling contact information and corresponding electronic devices and program products

(75) Inventor: Douglas Deeds, Bedford, TX (US)

Correspondence Address: HARRINGTON & SMITH, LLP, 4 RESEARCH DRIVE, SHELTON, CT, 06484-6212, US

(73) Assignee: Nokia Corporation

(21) Appl. No.: 11/127,989

(22) Filed: May 11, 2005

(51) Int. Cl. H04Q 7/20

(52) U.S. Cl. 455/41.2; 455/425

(57) ABSTRACT

An electronic communication device is disclosed that is arranged in connection with a caller party in order to communicate with a target party. The device includes a processor, communication modules for communicating with the said target party and a memory in which contact information concerning the said target party is arranged to be stored in order to communicate with the said target party. The processor is arranged to hide at least part of the said contact information from the said caller party but to permit the communication with the said target party defined by the contact information.

### FIELD OF THE INVENTION

The invention concerns electronic communication device arranged in connection with a caller party in order to communicate with a target party, which device includes
a processor,
communication modules for communicating with the said target party and
a memory in which contact information concerning the said target party is arranged to be stored in order to communicate with the said target party.

In addition, the invention also concerns methods and corresponding program products and also electronic device arranged in connection with a target party to be contacted by the caller party.

### BACKGROUND OF THE INVENTION

In our everyday lives different kind of situations appear where a user may wish to give away only enough information for them to be contacted, but without giving away their identity.

One application example of this kind of situation is presented in FIG. 1. Out a club CLB, guy A wants to get girl B's phone number so he can call her. Girl B would like to keep contact with guy A but she wouldn't want to give away her phone number because the guy A may turn out to be a creep, stalker, etc. with annoying or more dangerous behavior.

Another application example of this kind of situation is that parents may want to give out their cell phone number to a baby sitter, repair man, etc. for use during a one-time event, such as a night out or a repair. In this kind of application the parents doesn't necessary want that their cell phone number is available to that person after the event or repairing procedure.

The described problems above have not been previously solved. Prior art for distributing contact information are ways in which a person might create alternate sets of limited contact information that could be sent for different situations. For example, a user might create a contact with all of their data, one with business data only, one with personal data only, one with only a first name and email, one with only a first name and instant messaging name, etc. They could then send contact information appropriate to the current situation. However, the method of contact, phone number, email address, etc. is still visible to the recipient, so they can always track down the sender with due diligence.

The Internet provides some well known manners to perform communication in an anonymous way. However, these kinds of solutions are not suitable to be applied in the mobile communication contexts. Partly this is due to the fact that the mobile networks are tightly controlled by their operators and service providers. The operator or provider must always know the identity of the user due to the invoicing and via this fact the user identity is easy to provide to other users although the user in question doesn't even want to do so. Also, the mobile devices are designed in such a manner that they always provide the identity of the user (for example, a phone number) when she or he calls to one's device.

### SUMMARY OF THE INVENTION

The purpose of the present invention is to bring about a way to transfer personal information from one device to another and a way to handle that in electronic devices. The characteristic features of the electronic devices according to the invention are presented in the appended Claims 1 and 31. The characteristic features of the methods are presented in claims 11 and 45. In addition, the invention also concerns program products, whose characteristic features are presented in the appended Claims 21 and 38.

The first electronic device arranged in connection with a caller party in order to communicate with a target party, includes a processor, communication modules for communicating with the said target party and a memory in which contact information concerning the said target party is arranged to be stored in order to communicate with the said target party. The processor is arranged to hide at least part of the said contact information of the said caller party but to permit the communication with the said target party defined by the contact information.

The second electronic device according to the invention that is arranged in connection with a target party towards which a communication is arranged to be perform by a device of a caller party, includes a processor and communication modules to communicate with the said caller party in which communication includes at least sending of a contact information of the said target party to the device of the caller party. At least part of the said contact information to be sent to the device of the caller party is arranged to be configured in such a way that it is hidden from the said caller party but to permit the communication with the said target party defined by the contact information.

Furthermore, the invention concerns also methods for controlling contact information in an electronic communication device. According to the first method a user of the device may use the contact information in order to communicate with a target party defined by the contact information. At least part of the said contact information is hidden from the said user but it permits the communication with the said target party defined by the contact information.

According to the second method
a target party prepares the contact information concerning itself and sends it to a caller party,
the caller party receives the contact information concerning the target party and stores it to the device in order to communicate with the said target party defined by the contact information. The contact information concerning the target party and stored on the device of the said caller party is controlled by the said target party.

Furthermore, the invention concerns also program products for controlling contact information in an electronic communication device. The first program product is arranged to control contact information of a target party. Program product includes storing means and a program code executable by processor and written in the storing means. Program product is ordered to be arranged in connection with a device of a caller party. The program code includes
first code means configured to hide at least part of the said contact information from the said caller party and
second code means configured to permit the communication with the said target party defined by the contact information.

The second program product for controlling contact information of a target party includes storing means and a program code executable by a processor and written in the storing means. Program product is ordered to be arranged in connection with a device of a target party. The program code includes
first code means configured to configure at least part of the said contact information to be send to the device of the caller party in such a way that it is hidden from the said caller party but to permit the communication with the said target party defined by the contact information.

The invention provides new formats and methods for smart messaging of contacts as well as new manners for handling of the contacts. The invention also provides a manner to control contact information from another device.

Owing to the invention, numerous advantages to do communication between parties are achieved. A first advantage is that the invention improves upon earlier solutions by preserving a person's anonymity while still allowing them to be contacted.

According to one embodiment the contact information arranged in the device of the user may be controlled remotely by the target party. According to this embodiment the target party may according to one embodiment perform control messaging to the device of the caller party. According to one embodiment he or she may send with his device a control command. The command is received by the device of the caller party. The contact information in the device of the caller party is then processed in an established manner defined by the control messaging. One example of this processing may be the removing of the contact information from the device of the caller party.

According to one other embodiment the target party may set at least one criterion for the contact information. This criterion is monitored in the device of the caller party. When at least one criterion is fulfilled in a set manner in the device of the caller party the contact information is processed in a set manner. One example of this processing may be the removing of the contact information from the device of the caller party.

Other characteristic features of the invention will emerge from the appended claims, and more achievable advantages are listed in the specification.

### BRIEF DESCRIPTION OF THE DRAWINGS

The invention, which is not limited to the embodiments to be presented in the following, will be described in greater detail by referring to the appended figures, wherein

FIG. 1 is an application example of the invention,

FIG. 2a is a rough schematic view of a basic application example of the device and the program product to be arranged in connection with the device of the caller party according to the invention,

FIG. 2b is a rough schematic view of a basic application example of the device and the program product to be arranged in connection with the device of the target party according to the invention,

FIG. 2c is a rough schematic view of a basic application example of the device and the program product to be arranged in connection with the device according to the invention,

FIG. 3 shows a flowchart of the first application example of the invention,

FIG. 4 shows a flowchart of the second application example of the invention and

FIG. 5 shows a flowchart of the third application example of the invention.

### DETAILED DESCRIPTION OF THE INVENTION

The invention relates to the transfer of personal information from one device to another. The term “personal information” may be understood in the context of the invention very broadly. It may be, for example, such as first name, last name, phone numbers, email addresses, instant messaging names etc. and information that connects these network/communication references/addresses to some individual toward which the communication is possible.

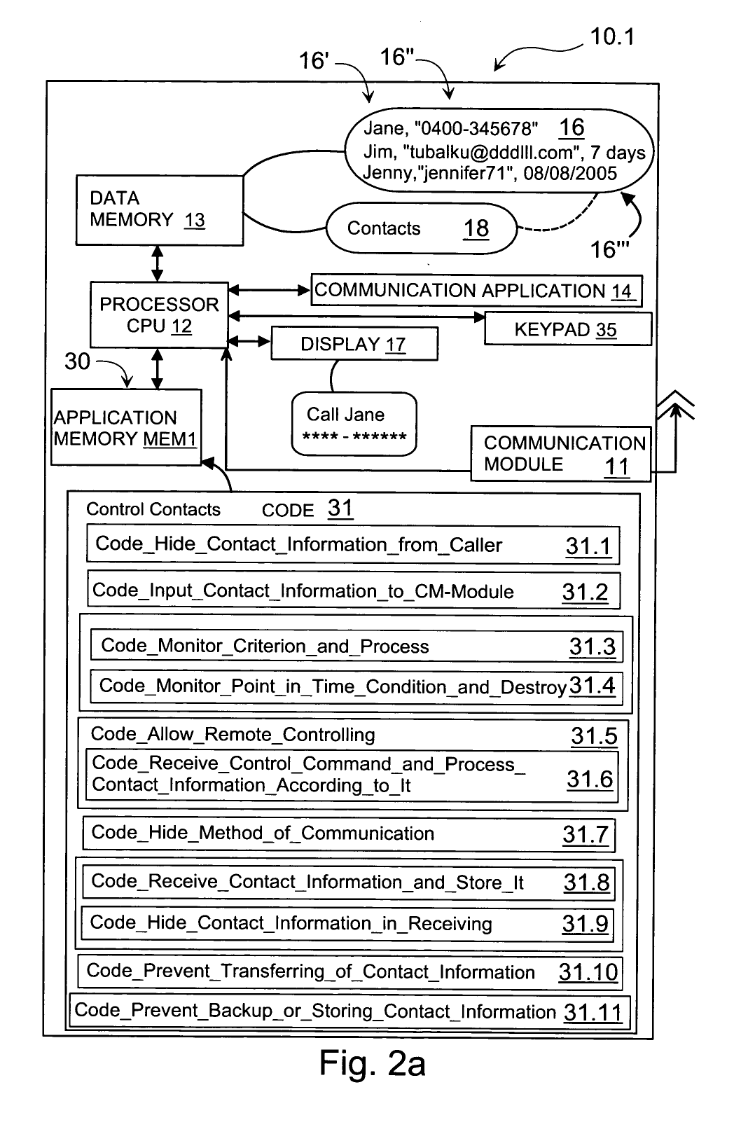

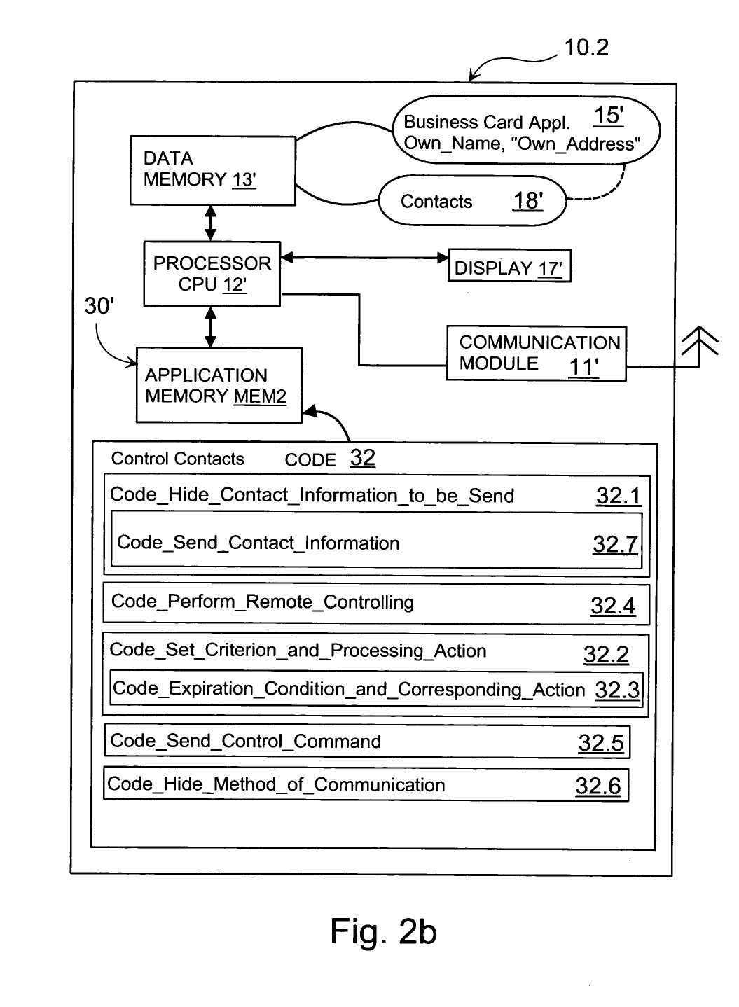

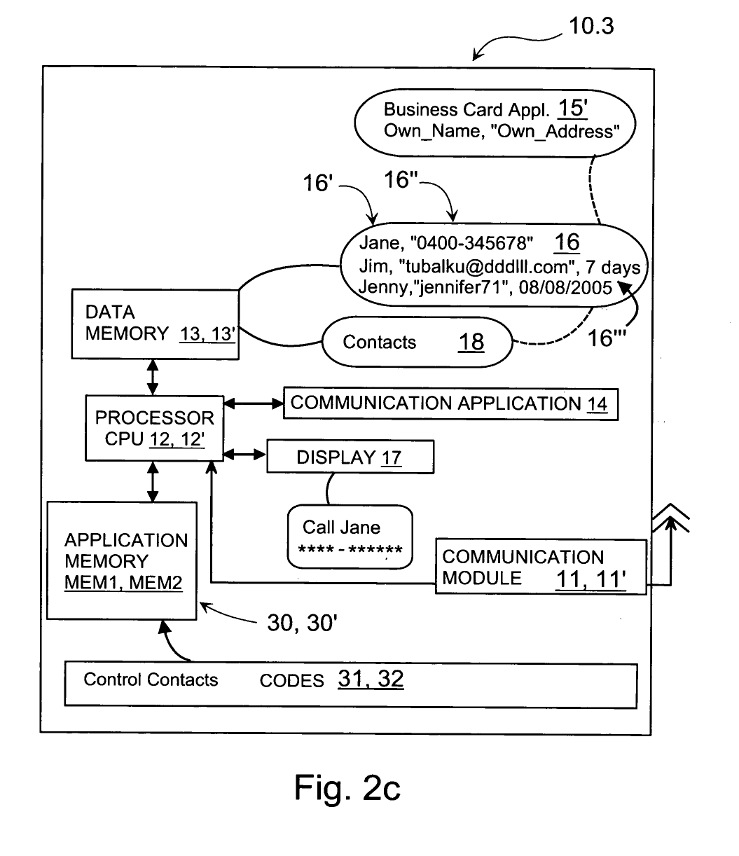

FIGS. 2a and 2b show examples of portable electronic communication devices 10.1, 10.2 according to the invention. The devices 10.1, 10.2 may be, for example, mobile devices, such as, for example, mobile phones, PDA devices (Personal Digital Assistant) or some equivalent intelligent communication devices (“smart devices”).

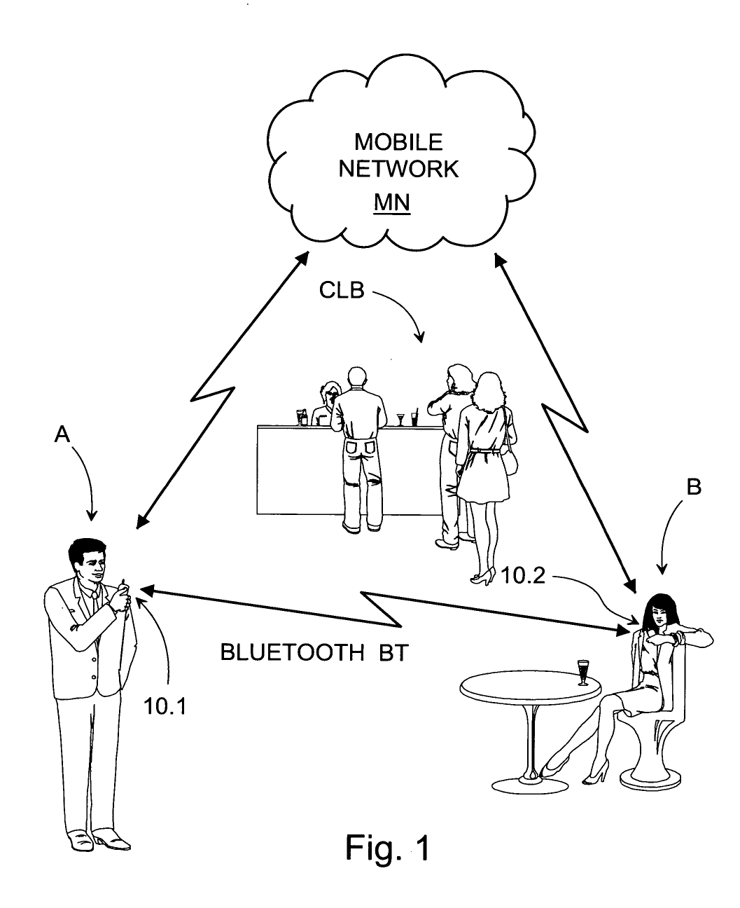

The devices 10.1, 10.2 according to the invention may be understood, in their simplest form, as a device 10.1 of a caller party A and a device 10.2 of a target party B. The first electronic communication device 10.1 may be arranged in connection with a caller A in order to communicate with a target B (reference to the prior art description and FIG. 1). Of course, the communication in the opposite direction is also possible initiating from the target B. Thus, the caller A may take contact or communicate with his or hers device 10.1 towards the device 10.2 of the target B in the manner according to the invention.

The term “contact” may be understood as a synonym for the term “communicate”. Correspondingly, the term “caller party” doesn't limit the invention to the voice calls or phone calls. The meaning of the term “caller party” is suggested to cover also data messaging aspects to which the invention may also be applied. The “caller party” may thus be understood as a “contactor” i.e. the party who intends to initiate the communication with someone else. Another meaning is that the “caller party” is a party to whom the contact information and the identity of the target party is never revealed if the target party so desires. The contact or communication may be performed in a desired manner the invention doesn't limit the manner of doing communication.

For one versed in the art it is quite obvious, when considering the practical implementation possibilities of the devices 10.1, 10.2, that the functionalities and features of the devices 10.1, 10.2 of the caller A and target B may be combined to be one uniform device 10.3. An example of this device 10.3 has been described in FIG. 2c. Then both persons A and B is to be understood as a caller that initiates a contact as well as a target that is a party to be contacted. This is quite apparent for one versed in the art.

In their basic form the devices 10.1, 10.2 may include communication modules 11, 11′, processors 12, 12′ and different kind of memories 13, 13′, MEM1, MEM2 arranged in the device 10.1, 10.2. The communication modules 11, 11′ may include one or more modules 11, 11′ that permits communication between the caller A and the target B by using a chosen network or several networks MN, BT. Modules 11, 11′ may include, for example, the transmitter and the receiver portions, which are very well defined in the current art.

Some examples of these communication methods and modules 11, 11′ are well defined wireless networks, like mobile communication networks MN and wireless local area networks BT. More particularly, one versed in the art may know these as WCDMA, CDMA, UMTS etc. networks definitions MN and Bluetooth BT, IrDA (Infrared Data Association), or WLAN (Wireless Local Area Network) networks. In these networks MN, BT there may be applied several bearers in order to communicate in a chosen manner. Some examples of these bearers are, SMS (Short Message Service), GPRS (for example, Email, Chat, IM-communication (Instant Message)) etc. For one versed in the art, the functions of these networks MN, BT, bearers and modules 11, 11′ are very apparent and no need for their precise description is not appropriate in this context.

The processors 12, 12′ may include one or several processor(s) 12, 12′ or corresponding. By means of these the functions of the devices 10.1, 10.2 are carried out in many contexts.

Both devices 10.1, 10.2 may also have data memory 13, 13′ or memories. In the caller device 10.1 there may be stored contact information 16′, 16″ or, in general, personal information of other parties. The contact information 16′, 16″ arranged in the caller's A device 10.1 may concern at least one or more target party B in order to communicate with him or her.

The contact information 16′, 16″ of target parties may be arranged, for example, in a database 16 to which, for example, the communication application 14 has an access. The contact information 16′, 16″ arranged in the database 16 may also be browsed via the user interface of the device 10.1. This may be performed, for example, through the display 17. These matters and methods are also very well known between ones versed in the art.

In the target device 10.2 (FIG. 2b) there may also be stored in its memory 13′ the contact information 16′, 16″. The contact information 16, 16′ may relate at least to the target party B himself or herself. It may have some kind of identification 16′, such as, a name “Own_Name” and some kind of network system reference, such as, “Own_Address”. The network reference 16″ may be, for example, a phone number. The contact information 16′, 16″ of the target party B is intended to be distributed to other possible parties, such as, to the caller A, in order to keep them in touch in the manner according to the invention.

The devices 10.1, 10.2 may also have functionalities to control and process the contact information 16′, 16″ of the other parties or of its own. In the case of the caller device 10.1 this means at least such features 18, 14 that allow browsing and selecting a party to be contacted in a desired manner. As said before, this may be a communication application, like an email application 14. In the case of the target device 10.2 this means at least such features that allow selecting the contact information 16′, 16″ to be sent to the selected party A from which the contacts is desired. In addition, there may be “Contacts” features 18, 18′ for these purposes in the devices 10.1, 10.2 of the parties A, B. Also, these Contacts-features 18, 18″ and their basic properties are well known in the midst of the experts. In the case of the target party B besides the Contacts-feature 18′ also a Business Card-application 15′ may be applied. Of course, the Business Card application 15′ may also be integrated in connection with the Contacts-feature 18′. Basic properties of the Business Card-feature 15′ are also apparent for one skilled in the art. In general, by it the target B may define which information he or she will send concerning himself or herself to other parties, such as, the caller party A. There may be different kind of options to select this information to sending.

The contact information 16′, 16″ to be selected in order to distribute to other the party A (=a caller) or parties in order to communicate with the chosen party or parties (=target parties) includes identification information 16′ and address information 16″ connected to the identification information 16′. Of course, other types of information are also possible which may have been included into the contact information.

The identification information 16′ concerning the target B may include, for example, some kind of reference to the party to be contacted. The caller A may connect this information 16′ easily to the person B in question. According to one embodiment this identification information 16′ may be, for example, a name or a nickname of the target B. In FIG. 2a some examples of this identification information 16′ are “Jane”, “Jim” and “Jenny”. In FIG. 2b example of this identification information 16′ is “Own_Name” that is intended to be send.

The address information 16″ connected to the identification information 16′ may include, for example, one or more address references to the chosen one or more networks or bearers. By using this address data the messaging can be relayed to the right recipient in the communication network MN. Some examples of these may be the phone numbers of the target B or email addresses of the target B. The phone number may be so called IMSI type (International Mobile Subscriber Identification) and it may allow different kind of communication methods. To the person “Jane” has connected in FIG. 2a a phone number that is “0400-345678”. Some examples of these bearers which phone number makes possible, may be voice call, SMSs, Chat, instant messaging. To the person “Jenny” has connected in FIG. 2a an instant message nickname “jennifer71”. The email address may allow email correspondence. To the person “Jim” has connected in FIG. 2a an email address that is “tubalku@dddlll.com”. One versed in the art understands about these examples presented in FIG. 2a that there may be several different kinds of address references using of which communication may be possible. Of course, it is also possible that to one person may be associated even several address references (not shown).

Next the devices 10.1, 10.2 will be described in a manner that is more focused to the invention. For the skilled person, it is obvious that the devices 10.1, 10.2 may also include other such functionalities, which are not required to describe more detailed in this application context. In addition, the function entities of the devices 10.1, 10.2 described hereinafter can, of course, take care out of many other matters and functions than which are considered to be appropriate to describe in this connection in order to illustrate the basic idea of the invention. For the skilled person it is obvious that at least part of the functions, operations and procedures of the invention may be performed in a program level executed by the processors 12, 12′. Of course, the implementations in which part of the operations are performed on program level and part of the operations are performed on the hardware level, is also possible. Next in the relevant points are referred to these program code means by means of which the device operations may be performed according to one embodiment. The program code means 31.1-31.11, 32.1-32.6 forming the program code means 31, 32 are presented in FIG. 2a, 2b.

In the invention the devices 10.1, 10.2 of the caller A and the target B have been configured in such a way that they make possible to leave the relevant data unidentified. This means that the device 10.1 of the caller A doesn't make the caller A aware of the relevant contact information 16″ but, however, the device 10.1 permits him or her to communicate with his or hers device 10.1 with the target A that is defined by the contact information 16″ in question.

Firstly, the device 10.1 will not output any information by its output means, such as, for example, on a display 17 or via a loudspeaker, which would lead to such situation in which the caller A would recognize or identify the target party B or in otherwise to derive his or hers real identity. Some contact information 16′ may be output, for example, in the display 17 in order to, for example, to form a communication connection with the desired party.

Secondly, the device 10.1 according to the invention is also configured in such a way that the caller A can't identify the real identity of the target B by, for example, sending his or hers (=target's) hidden address information 16″ to some network service provider using which the identification and other details are usually found out.

In the invention the processor 12 of the caller's A device 10.1 is arranged to hide at least part of contact information 16″ from the caller A but, however, to permit the communication with the target B defined by the contact information 16′, 16″. This means that identifiable methods of contact the user B, such as phone number, IM name, or email address, in general the address information 16″, are hidden at least partly from the caller A.

The hiding of the contact information 16, 16″ may be performed in one or more contexts of the invention. First option is to perform hiding according to the invention in connection with the communication measures, i.e. in which the caller A initiates, performs or finishes the communication towards target B. Other options are when the caller A accepts the phone call attempt of the target B or receives the message which communication in these cases initiates from the target's B side.

One more cases in which the hiding according to the invention is to be understood are when receiving of the contact information 16′, 16″ from the target B. According to prior art at least part of the contact information 16″ is in these cases shown on the display 17 of the caller's A device 10.1. According to the invention these relevant contact information 16″ which would otherwise name the target B is also hidden in connection with the receiving procedure of the contact information 16′, 16″. This may take care out of by program code means 31.9. The device 10.2 may have corresponding code means which control this setup.

Yet, one more case in connection with the identity of the target B is also keep secret is the situation, for example, after the contact information 16′, 16″ is deleted from the caller's A device 10.1. One example to prevent this kind of measures is to prevent the further distribution of the contact information 16′, 16″ to some other device or party. To take care out of this there are program code means 31.10 configured to prevent the caller party A or his device 10.1 from transferring the relevant contact information 16′, 16″ to any other device. The device 10.2 may have corresponding code means which control this setup.

When the caller A has received the contact information 16′, 16″ of the target B he or she is prevented to distribute that information to some other devices, for example, to a mobile device of third party or to a PC-device owned by caller A. The distribution may be forbidden in any cases and even if the other mobile device would be the caller's A own device. This forbids the determining of the identity of the target B after the contact information 16′, 16″ has been deleted from the device 10.1 and, of course, also in that case when the contact information 16′, 16″ is still active in the device 10.1. If the distribution would be allowed, then, for example, by using the laptop's PC-suite for backup a phone 10.1 would allow to determine the identity of the target B, if the laptop itself or the PC-suite would not be equipped in the manner according to the invention. This program code means 31.11 prevents the backup or other storage measures of contact information in means capable of disclosing the hidden parts or elements of contact information 16″. The device 10.2 may have corresponding code means which control this setup. If the contacts 16 are stored to the memory 13 of the device 10.1 the transfer of them to the SIM-module (Subscriber Identity Module) may also be prevented. This prevents the caller A to move the contacts 16 by using the SIM to some other device by using of which he may find out the real identity of the target party B.

The hiding method of the contact information or at least part of it may be completely or partial. If complete hiding is applied nothing are presented about the address information 16″. If partial hiding is applied some of the information 16″ may be present. This means that, for example, the beginning of the phone number 16″ i.e. “0400-******” is only presented or only the rest of the email address 16″ i.e. “******@dddlll.com”.

In the case of the phone number 16″, this kind of partial presentation of phone number 16″ allows for the caller A to conclude the connection costs when performing phone call communication towards target B having phone number beginning 0400-. However, the identity of the target B doesn't expose to caller A from this kind of partial presentation of call code number 16″.

The general idea of the invention is that the contact information 16′, 16″ concerning the target B that is stored on the device 10.1 of the caller A is controlled by the target B. In the method a program code 31 arranged in connection with the caller's A device 10.1 is used that checks whether the contact information 16′, 16″ is meant or not to be brought into consciousness of the caller A.

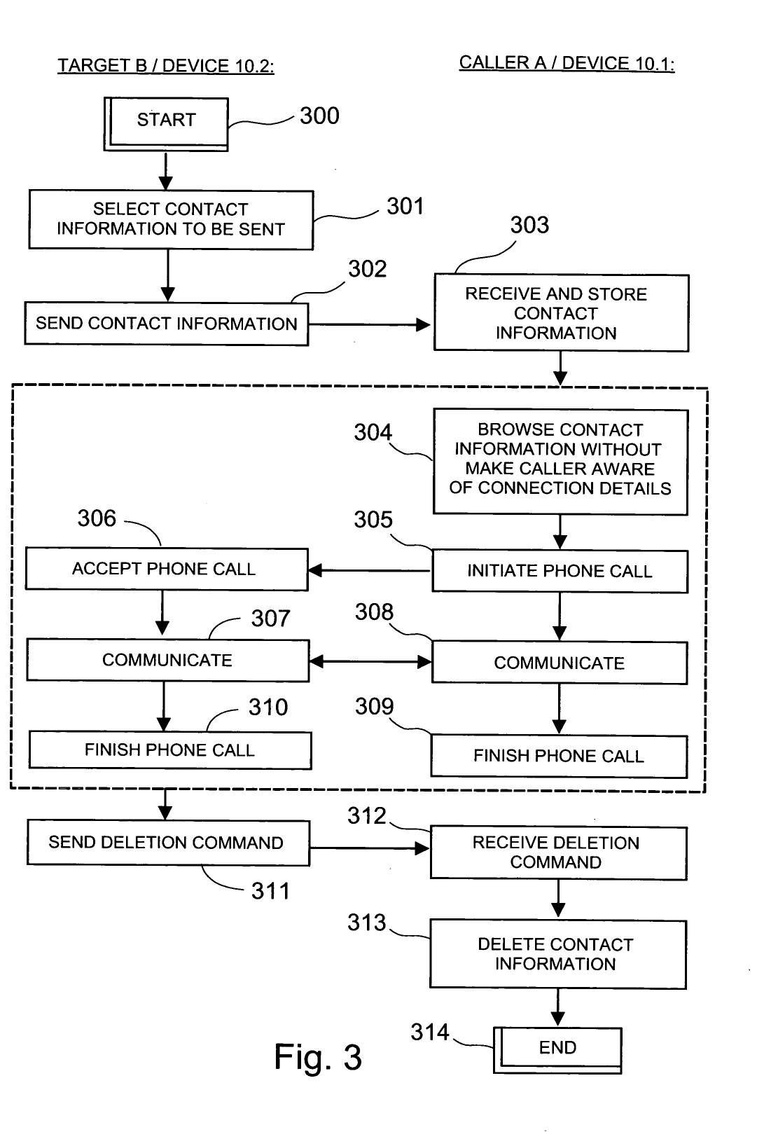

Next the method for control a contact information 16′, 16″ in the electronic communication device 10.1 is described in connection with the several different embodiments. The first embodiment is made in the case of remote control with reference to the flowchart of the FIG. 3. For one versed in the art it is apparent that the different embodiments below and above may be combined in the sense of the invention.

In the first embodiment, after start stage 300 of the procedure, in stage 301 the target user B may designate with his or her device 10.2 which fields will be transferred when the contact information 16′, 16′ concerning his or her will be sent to a non-trusted recipient i.e. user A, for example. More general, the target B prepares the contact information 16′, 16″ concerning herself or himself and then he or she sends it to the caller A. Preparing of the contact information 16′, 16″ to be send may be performed, for example, by using the Business Card-feature 15′ implemented in the device 10.2 by the processor 12′.

More detailed, the target B prepares the contact information to be send with his or hers device 10.2 in such way that at least part of the contact information 16″ that is intended to send to the device 10.1 of the caller A is configured in such a way that it is hidden from the caller A. This may be performed by using the program code means 32.1. This means that at least part of the contact information 16″ has been configured in a such manner that at least set part of the contact information 16″ is not brought into consciousness of the caller party A i.e. the recipient of the contact information 16′, 16″ but, however, it permits the communication with the target B defined by the contact information 16′, 16″.

An example of this preparing or configuration procedure would be to select only the user's B first name Own_Name (=Jane) or her nickname to transfer plus a means (=Own_Address) to contact the user B. This may be, according to this embodiment, for example, the phone number of his or her device 10.2 “0400-345678”. If applying Business Card type of feature 15′, the user B can now select whether to send a full card or a partial card. If the user B selects a partial card, only the information that the user has previously selected is transferred to the recipient i.e. to the caller A in the future. In this stage 301 the target party B may also select which information in the contact information 16′, 16″ would be such that is appropriate to process according to the invention i.e. to hide.

One embodiment to perform this hiding is to connect a flag or some other kind of indication to such one or more data fields of information, which are not allowed to bring aware of the caller A. The hiding flag may be set for the phone number data field in the Business Card-feature 15′ of the device 10.2. Flag is described in FIG. 2b as “” signs. The Own_Address data field intended to be send is there set between these “”—signs. More sophisticated embodiments are also possible, of course. The manner how the hidden elements 16″ are indicated or how they are recognized doesn't limit the implementation possibilities of the invention.

In stage 302 the target B sends this prepared and configured contact information 16′, 16″ of her own at least partly hidden to the device 10.1 of the caller A using the transmitting modules 11′ of the device 10.2 which are part of the communication modules of the device 10.2. This may be performed by using the program code means 32.7. Thus, she communicates with the caller A in which communication includes now at least sending of this contact information 16′, 16″ of the target party B to the device 10.1 of the caller party A. Sending may be performed in a known manner using, for example, mobile networks MN or local area networks BT.

In stage 303 the caller A receives by using the communication modules 11 of the device 10.1 the contact information 16′, 16″ concerning the target B and stores it to the device's 10.1 contacts database 16 in order to communicate in the future with the target B defined by the received contact information 16′, 16″. This may be performed by using the program code means 31.8. The stage 303 is performed in such a way that the processor 12 is further arranged to hide at least part of the contact information, such as, for example, the address data 16″ of the target B shown to the caller A upon receipt of contact information 16′, 16″ (code means 31.9).

Next stages 304-310 that have been presented in FIG. 3 in the dashed line box, are not relevant at all when considering the basic idea of the invention. The purpose of the dashed line box procedure is only intended to illustrate the basic idea of the invention when communicating between parties A, B. The measures, that may be performed in the device 10.1 may have different kind of forms, the invention doesn't limit them to some particular one or a way of communication.

In stage 304 the user A of the device 10.1 may use the contact information 16′, 16″ of the target B in order to communicate with the target B defined by the contact information 16′, 16″. According to the method and the device 10.1 at least part of the contact information 16″ is hidden from the caller A i.e. now the user of the device 10.1 but, however, the contact information 16″ stored in the device 10.1 surprisingly permits the communication with the target B defined by the contact information 16′, 16″ by using this device 10.1. Thus, the identity of the target B doesn't reveal in any circumstances, if she or he doesn't want so to happen. In general, any kind of browsing of the information stored on the device 10.1 or use of the device 10.1 doesn't reveal or provide any kind of clues about the identity of the target B but the all relevant information 16″ which may expose or may be used to expose the identity is hidden from the caller A.

The recipient i.e. the caller A can now view the contact in the Contacts list 18 retrieved from the database 16, however the phone number “0400-345678” is hidden from the recipient A. This may be performed by using the program code means 31.1. The code means 31.1 are configured now in such a manner that they recognize the flag i.e. now the “” signs around the phone number 16″. Due to this reason the phone number 16″ is not shown on the display 17 of the device 10.1. Thus, the recipient A can contact the sender B of the contact information 16′, 16″, but the phone number is never revealed.

The next stages 305-310 may be very apparent for one versed in the art. In stage 305 the user A may initiate in a well known manner a phone call towards the target B but the user A does not know the target user's B full name and cannot give out his or hers phone number. This may be performed by using the program code means 31.2. In this stage the user A may perform browsing in the user interface UI of the device 10.1 and select target B in order to initiate a phone call towards him or her. This may be performed by using the program code means 31.1. However, the phone number of the user B is shown on the display 17 of the device 10.1 some hidden manner if at all. It may be shown as stars like presented in FIG. 2a. Other cryptic manners are also possible which may depend, for example, on the device or UI manufacturers.

In stage 306 the target B answers to phone call i.e. accepts the contact attempt. In stages 307, 308 the parties A, B communicates between each other and in stages 309, 310 they finish the phone call. However, the phone number 16″ of target B is hidden all the time from the caller A. By this there may be, of course, other kinds of type of communications, about which examples are presented below.

According to this embodiment, the contact information 16′, 16″ sent to the device 10.1 of the caller A is arranged to be controlled remotely by the device 10.2 of the target B. This may be perform by using the program code means 32.4. In this embodiment the device 10.2 is arranged to send by using the communication modules 11′ a control command to the device 10.1 of the caller A in order to process the contact information 16′, 16″ stored in the memory 13 in an established manner defined by the sent control command. This command may have an established format, for example, being a smart message and it may be formed in the Contacts feature 18′, for example. These measures may be performed by using the program code means 32.5. This control command may be understood as one embodiment for the control messaging that may be performed towards the device 10.1 of the caller party A by the device 10.2 of the target party 10.2. The control messaging may include one or more command messages.

In stage 311 that may be even right after a contact information 16′, 16″ has been received and stored by the non-trusted recipient A, the target user B can send a new format of smart message as a command, which will be a ‘recall’ or ‘delete contact’ message. This may be understood as a one example of the remote control of the contact information 16′, 16″ in this embodiment context. The control command has been formed by processor 12′ and it is sent by communication modules 11′ that both actions may be controlled by program code means 32.5.

The ‘recall’ message received by the communication modules 11 of the device 10.1 in stage 312 will cause the recipients A handset 10.1 to automatically delete the previously received contact information 16′, 16″ in question by its processor 12. This will happen in stage 313. Both actions may be performed by program code means 31.5, 31.6. According to one embodiment the reception of the ‘recall’ message will not be shown the recipient A and the deletion of the concerned contact information 16′, 16″ will also not be show or bring to the caller's A attention. The procedure ends to the stage 314. The device 10.1 is configured in such a way that it allows the remote control of contact information 16′, 16″ of other parties. This may be performed by using the program code means 31.5. The remote management is only possible for the party B in question whose own contact information 16′, 16″ is in the caller's A device 10.1. Thus, target B can only control contact information 16′, 16″ that is connected to him or her i.e. that he or she has also usually sent.

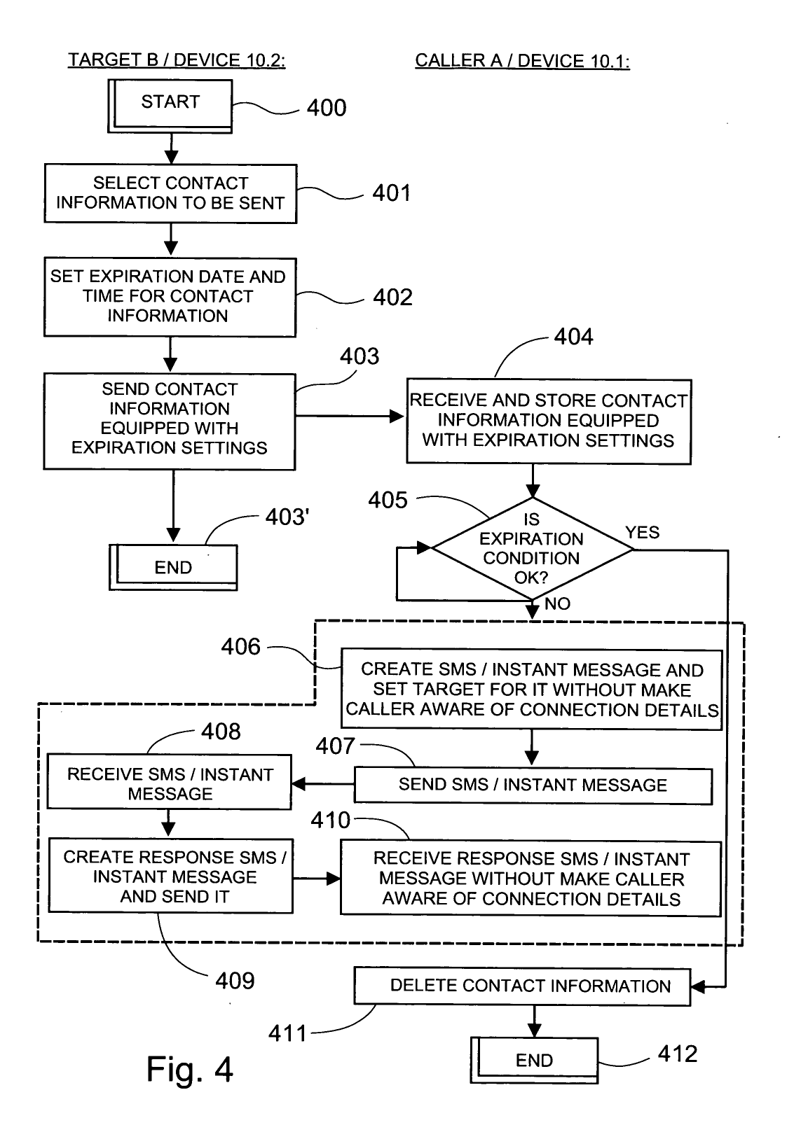

FIG. 4 discloses the second embodiment of the invention. In this embodiment after starting stage 400 the target user B may also designate in stage 401 which fields will be transferred when the contact information 16′, 16″ is sent in stage 403 to a non-trusted recipient i.e. caller party A. Now this information may include his or hers identification “Jenny” and his or hers IM-address or nickname “jennifer71” in the instant messaging system (Chat).

At stage 401 the user B also chooses now, at the time of sending, whether to send a full or partial contact information card. In this embodiment, the user B also selects at stage 403, at the time of sending, either a duration or a time/date or some other criterion or the combination of them when the contact will, for example, expire in the recipient's A handset 10.1. This may be performed by processor 12′ and the program code means 32.2, 32.3 may take care out of these actions.

More general in stage 402 by the processor 12′ of the device 10.2 is arranged to set at least one criterion for the contact information 16′, 16″ to be send. In addition, the processor 12′ is also arranged to set at least one processing action relating to the contact information 16′, 16″ to be sent. The established processing action(s) are ordered to be activated in the device 10.1 of the caller A when the criterion set for it is fulfilled in a set manner. The duration or time/date, in general, a point in date/time or a validation time of the contact information 16′, 16″ are only one examples of this kind of criterions.

In this embodiment the criterion is a date, for example, “08/08/2005” and the processing action may be, for example, a destroying of the contact information 16′, 16″ from the device vice 10.1 of the caller A in a set manner. If the destroying is a default procedure, that is recognized from the date field.

In stage 403 the contact information 16′, 16″ equipped with the set criterion “08/08/2005” is sent and in stage 404 it is received and stored with the device 10.1. In this case the processor 12 may also be configured in such way that it hides at least part of the address information 16″ of the target B shown to the caller A upon receipt of contact information 16′, 16″ (code means 31.9).

After the contact information 16′, 16″ has been received and stored by the non-trusted recipient A in stage 404, the hand-set 10.1 may as a stage 405 periodically (every minute, for example) check to see if a timeout or duration has occurred for a stored contact information 16′, 16″ in question. More general, the processor 12 monitors at least one criterion set for the concerned contact information 16′, 16″ by the target B and when at least one criterion is fulfilled in a set manner the contact information 16′, 16″ in question is processed in a set manner. This may be performed by using the program code means 31.3, 31,4. In FIG. 4 the closed loop in connection with stage 405 illustrates this performance i.e. the “NO” route divides into two branches. When the timeout or duration 16′″ (i.e. now 08/08/2005) occurs, the contact information 16.1′, 16″ connected to this condition 16′″ is deleted from the contact list database 16. According to one embodiment this may be performed without any message to the user A of the device 10.1. Also, the user A of the device 10.1 can't see or decode the expiration date/time or duration time 16′″.

In this embodiment, too, the general actions that may be performed by the device 10.1 are again presented in dashed line box. Here the communication example is SMS or instant message correspondence.

In stage 406 the user A creates the SMS/IM message and in stage 407 he sends it to the target B. The communication application 14 is in this case, for example, Chat application. In stage 408 the message is received and in stage 409 a response message is created and sent back to the caller A by the target B. The caller A receives response in stage 410. For every steps it is essential, when considering this communication in the aspects of the invention, that the identity of the target B doesn't reveal during messaging or before it or after that. The device 10.1 has been configured in such a manner.

When the expiration condition 16′″ monitored in stage 405 by processor 12 of the device 10.1 is correct, i.e. now the expiration date 08/08/2005 has been reached, the device 10.1 instructs itself to delete the contact information 16′, 16″ from its database 16. The step to stage 411 is performed and at least part of the contact information 16′, 16″ concerning the person B in question disappear from the device 10.1 permanently. This may be performed by using the program code means 31.3, 31.4. The user A can't trace it any more or restore it to the device 10.1. The procedure relating to the invention finishes to stage 412. This embodiment and the stages above may also be understood as a certain kind of remote controlling of the contact information 16′, 16″. The condition term set by the target user B causes actions in the database 16 of the remote device 10.1.

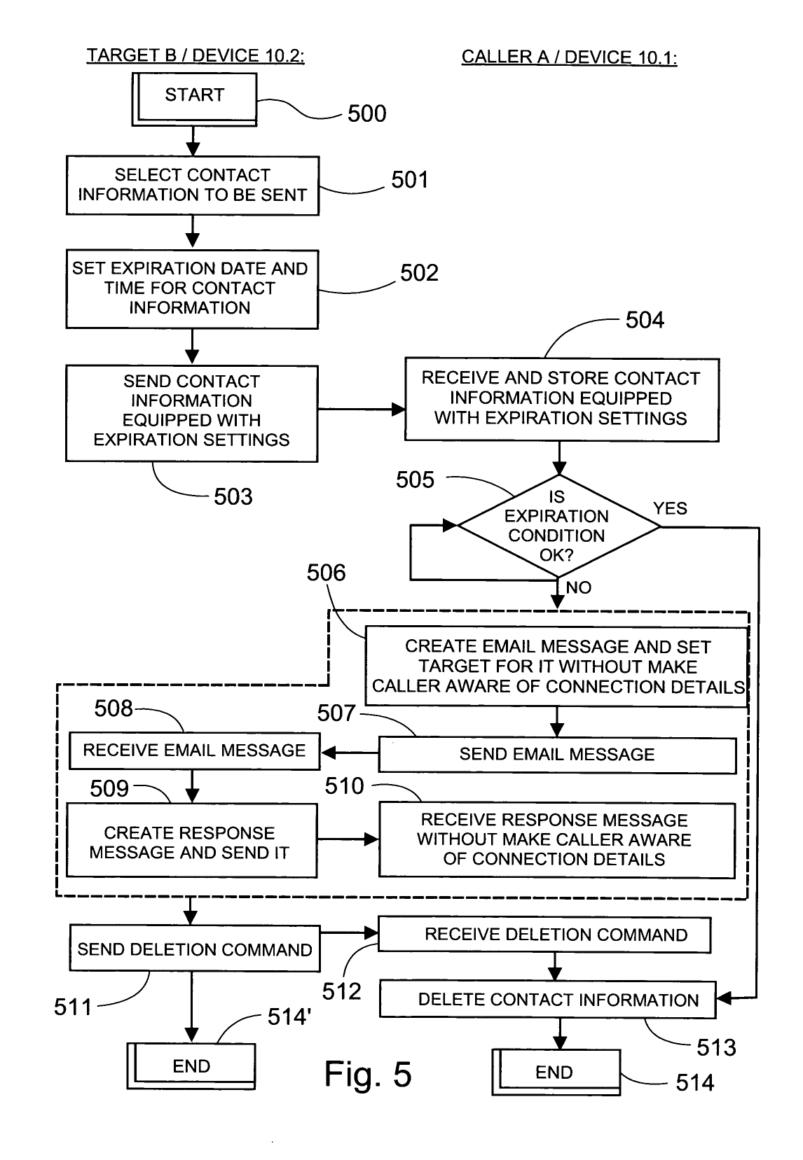

The embodiment described in FIG. 5 is a certain kind of combination of embodiments of FIGS. 3 and 4 when considering the remote control of the contact information 16′, 16″. It shows that the general idea of the invention may be combined in order to implement different kind of implementations that are possible in the sense of the invention. The stage descriptions presented in the case of FIGS. 3 and 4 are mainly equivalent. Only the differing steps are now described.

Now the contact information 16′, 16″ may include person's name “Jim” and his email address “tubalku@dddlll.com”. After start step of the procedure 500 it is in stages 501-503 assembled to be send and equipped with duration time “7 days” in order to remove it from the device 10.1 after that. In stage 503 it has been sent and in stage 504 it has been received and stored in a manner already described prior embodiments. Here again, the processor 12 may be configured in such way that it hides at least part of the address 16″ of the target B shown to the caller A upon receipt and storing stage 504 of contact information 16′, 16″ (code means 31.9). This part may be, for example, the address code, such as, an email address 16″.

Now the expiration condition is also monitored in stage 505. The closed loop in connection with stage 505 illustrates this performance that is performed by the processor 12 as a continuous procedure in an established manner. The communication embodiment in this case is email correspondence. Stages 506-510 in a dashed box are well defined according to prior art (email correspondence procedure in general) and the prior description of the basic idea of the invention. The communication application 14 is in this embodiment the Email application of the device 10.1.

However, if the target B doesn't want to reveal his or her identity, he or she must use in stage 509 some suitable communication method in order to response to the email message send by the caller A. If the target B answers by using email known as such, the caller A may find out his or her identity. He or she may found out this by using, for example, PC-computer by means of which he or she reads the response email send by target B. If the PC-computer is, for example, a public device (being in the library, for example) and thus not necessarily equipped with the functionalities according to the invention, the identity of the target B may reveal. If the target B uses some other communication method in his or her response, for example, mobile messaging method (i.e., for example, SMS or IM) he or she may still be non-revealed. This may require that the target has given besides his or her email address his or her mobile address to the caller A and this has been performed in the manner according to the invention. This ensures that the identity of the target B doesn't reveal when the caller A receives the response message by using some other communication method than email. Thus, the invention may be more focused to the wireless mobile communication methods than to the computer related communication.

If the monitored condition i.e. the duration “7 days” is reached the procedure goes like in the embodiment of FIG. 4. However, in this embodiment the user “Jim” may also perform remote control of the contact information 16′, 16″ concerning himself. If he wants so that the contact information 16′, 16″ must be deleted already before the expiration condition is fulfilled he may in stage 511 send a control message according to the embodiment of FIG. 3. This may be performed immediately when he wants so. The reason for this may be, for example, terrorizing messaging behaviour of the caller A. This causes corresponding procedure presented and described in connection with the FIG. 3 and the contact information 16′, 16″ disappear in stage 513 from the device 10.1 before that was originally intended to disappear. Possibilities to implement the invention are thus various.

In FIGS. 2a and 2b are presented a rough schematic view of application examples of a program products 30, 30′ according to the invention. The program product 30 may be arrange in connection with the device 10.1 of the caller A and the program product 30′ may be arrange in connection with the device 10.2 of the target B. The program products 30, 30′ may include storing means MEM1, MEM2 and a program codes 31, 32 executable by the processor units 12, 12′ of the devices 10.1, 10.2 and written in the storing means MEM1, MEM2 for dealing out controlling of the contact information 16′, 16″ in accordance with the method of the invention at least partly in the software level. The storing means MEM1, MEM2 for the program codes 31, 32 may be, for example, a static or dynamic application memories of the devices 10.1, 10.2, wherein it can be integrated directly, for example, in connection with the communication applications 14 or with the Contacts feature 18, 18′ of the user interface or with the Business Card application/feature 15′.

The program codes 31, 32 may include several code means 31.1-31.11, 32.1-32.7 described above, which can be executed by processors 12, 12′ and the operation of which can be adapted to the method descriptions just presented above. The code means 31.1-31.11, 32.1-32.7 may form a set of processor commands executable one after the other, which are used to bring about the functionalities desired in the invention in the devices 10.1, 10.2 according to the invention.

Although, the invention has been described in the above in embodiments in which the caller device 10.1 is presented on its own and the target device 10.2 is presented on its own, for one versed in the are it is obvious that the features of these both devices 10.1, 10.2 may also be implemented in one device 10.3. A rough schematic example of this device 10.3 has been described in FIG. 2c.

According to one more embodiment the method of communication may also be hidden. This may be performed by using the program code means 31.7, 32.6. According to this embodiment the caller A doesn't know which method has been used for the communication. The caller A may, for example, write his or her message in some text editor of the device 10.1, choose the target B to which the message is to be sent and send it. The device 10.1 sends the message using the hidden address data 16″ and now, also using the hidden bearer. The bearer may be in this embodiment, for example, email or SMS. For dealing out this embodiment the devices 10.1, 10.2 may be equipped by program code means 31.7, 32.6.

Correspondingly, when the caller A receives, for example, a response for his message, the observing of that will be happen in some neutral environment (for example, in the same text editor/viewer environment in which the message was written). The receiving of the message will also not reveal the method of contact or the real identity of the target B who sent the response message in question.

It should be understood that the above specification and the figures relating to it are only intended to illustrate the present invention. Thus, the invention is not limited only to the embodiments presented above or to those defined in the claims, but many various such variations and modifications of the invention will be obvious to the professional in the art, which are possible within the scope of the inventive idea defined in the appended claims.

What is claims is:

1. An electronic communication device arranged in connection with a caller party in order to communicate with a target party, which device includes
a processor,
communication modules for communicating with the said target party and
a memory in which contact information concerning the said target party is arranged to be stored in order to communicate with the said target party,
characterized in that the processor is arranged to hide at least part of the said contact information from the said caller party but to permit the communication with the said target party defined by the contact information.

2. An electronic device according to claim 1, characterized in that the contact information includes identification information concerning the said target party and address information connected to the said identification information and at least part of the said address information is arranged to be hidden.

3. An electronic communication device according to claim 1, characterized in that the processor is arranged to monitor at least one criterion set for the said contact information by the target party and when at least one criterion is fulfilled in a set manner the contact information is arranged to be processed in a set manner.

4. An electronic communication device according to claim 3, characterized in that the said criterion is a point in time and the said processing is a destroying of the said contact information from the device in a set manner.

5. An electronic communication device according to claim 1, characterized in that the contact information is arranged to be controlled remotely by the said target party.

6. An electronic communication device according to claim 5, characterized in that the device is arranged to receive, by using the communication modules, a control messaging from the said target party and the processor is arranged to process the contact information in an established manner defined by the said control messaging.

7. An electronic communication device according to claim 2, characterized in that in addition with the said address information the method of communication is arranged to be hidden.

8. An electronic communication device according to claim 1, characterized in that the processor is further arranged to hide at least part of the contact information of the target party from the caller party in connection with the receiving of the contact information.

9. An electronic device according to claim 1, characterized in that the processor is arranged to prevent the transferring of the contact information to any other device.

10. An electronic device according to claim 1, characterized in that the processor is arranged to prevent the backup or other storage of the said contact information in means capable of disclosing the hidden parts of the said contact information.

11. A method for controlling contact information in an electronic communication device in which a user of the device may use the contact information in order to communicate with a target party defined by the contact information, characterized in that at least part of the said contact information is hidden from the said user but the communication is permitted with the said target party defined by the contact information.

12. A method according to claim 11, characterized in that the contact information includes identification information concerning the said target party and address information connected to the said identification information and at least part of the said address information is hidden.

13. A method according to claim 11, characterized in that the target party sets at least one criterion for the said contact information which criterion is monitored in the device of the user and when at least one criterion is fulfilled in a set manner the contact information is processed in a set manner.

14. A method according to claim 13, characterized in that the said criterion is a point in time and the said processing is a destroying of the said contact information from the device of the user in a set manner.

15. A method according to claim 11, characterized in that the said target party performs remote controlling of the said the contact information arranged in the device of the user.

16. A method according to claim 15, characterized in that the target party performs a control messaging to the device of the user and the contact information in the device of the user is processed in an established manner defined by the said control messaging.

17. A method according to claim 12, characterized in that in addition with the said address information the method of communication is hidden.

18. Method according to claim 11, characterized in that at least part of the said contact information of the target party is further hidden from the caller party in connection with the receiving of the contact information.

19. Method according to claim 11, characterized in that the transferring of the contact information to any other device is prevented.

20. Method according to claim 11, characterized in that the backup or other storage of the said contact information in means capable of disclosing the hidden parts of the said contact information is prevented.

21. A program product for controlling contact information of a target party, which program product includes storing means and a program code executable by processor and written in the storing means, and which program product is ordered to be arranged in connection with a device of a caller party, characterized in that the program code includes
first code means configured to hide at least part of the said contact information from the said caller party and
second code means configured to permit the communication with the said target party defined by the contact information.

22. A program product according to claim 21, characterized in that the contact information includes identification information concerning the said target party and address information connected to the said identification information and at least part of the said address information is arranged to be hidden by the said first code means.

23. A program product according to claim 21, characterized in that the program code comprises third code means configured to monitor at least one criterion set for the said contact information by the target party and when at least one criterion is fulfilled in a set manner the contact information is arranged to be processed in a set manner.

24. A program product according to claim 23, characterized in that the said criterion is a point in time and the program code comprises fourth code means configured to destroy the said contact information from the device in a set manner.

25. A program product according to claim 21, characterized in that the program code comprises fifth code means configured to allow the remote controlling of the said contact information by the target party.

26. A program product according to claim 25, characterized in that the program code comprises sixth code means configured to receive a control messaging from the said target party and to process the contact information in an established manner defined by the said control messaging.

27. A program product according to claim 22, characterized in that the program code comprises seventh code means configured to hide the method of communication in addition with the said address information.

28. Program product according to claim 21, characterized in that the program code comprises ninth code means configured to hidden from the caller party at least part of the said contact information of the target party in connection with the receiving of the contact information.

29. Program product according to claim 21, characterized in that the program code comprises tenth code means configured to prevent the transferring of the contact information to any other device.

30. Program product according to claim 21, characterized in that the program code comprises eleventh code means configured to prevent the backup or other storage of the said contact information in means capable of disclosing the hidden parts of the said contact information.

31. An electronic communication device arranged in connection with a target party towards which a communication is arranged to be performed by a device of a caller party, which device of the target party includes
a processor and
communication modules to communicate with the said caller party in which communication includes at least sending of a contact information of the said target party to the device of the caller party,
characterized in that at least part of the said contact information to be send to the device of the caller party is arranged to be configured in such a way that it is hidden from the said caller party but the communication is permitted with the said target party defined by the contact information.

32. An electronic communication device according to claim 31, characterized in that the contact information sent to the device of the caller party is arranged to be controlled remotely by the device of the target party.

33. An electronic device according to claim 31, characterized in that the contact information includes identification information concerning the said target party and address information connected to the said identification information and at least part of the said address information is arranged to be configured in such a way that it is hidden in the device of the caller party.

34. An electronic communication device according to claim 32, characterized in that by the processor is arranged to set
at least one criterion for the said contact information to be send and
at least one processing relating to the contact information and the said criterion set for it that processing is ordered to be activated in the device of the caller party when the said criterion is fulfilled in a set manner.

35. An electronic communication device according to claim 34, characterized in that the said criterion is a point in time and the said processing is a destroying of the said contact information from the device of the caller party in a set manner.

36. An electronic communication device according to claim 32, characterized in that by the device is arranged to perform by using the communication modules a control messaging to the device of the said caller party in order to process the contact information in an established manner defined by the said control messaging.

37. An electronic communication device according to claim 33, characterized in that in addition with the said address information the method of communication is arranged to be hidden.

38. A program product for controlling contact information of a target party, which program product includes storing means and a program code executable by a processor and written in the storing means, and which program product is ordered to be arranged in connection with a device of a target party, characterized in that the program code includes
first code means configured to configure at least part of the said contact information to be send to the device of the caller party in such a way that it is hidden from the said caller party but the communication is permitted with the said target party defined by the contact information.

39. A program product according to claim 38, characterized in that the contact information includes identification information concerning the said target party and address information connected to the said identification information and at least part of the said address information is configured to be hidden by the said first code means.

40. A program product according to claim 38, characterized in that the program code comprises second code means configured to set at least one criterion for the said contact information to be send and when at least one set criterion is fulfilled in a set manner the contact information is arranged to be processed in a set manner by the device of the caller party.

41. A program product according to claim 40, characterized in that the said established criterion is a point in time and the program code comprises third code means configured to set a destroy order for the said contact information from the device of the caller party in a set manner.

42. A program product according to claim 38, characterized in that the program code comprises fourth code means configured to allow the remote controlling of the said contact information by the target party.

43. A program product according to claim 42, characterized in that the program code comprises fifth code means configured to perform a control messaging to the said caller party and to process the contact information in an established manner defined by the said control messaging.

44. A program product according to claim 39, characterized in that the program code comprises sixth code means configured to hide the method of contact in addition with the said address information.

45. A method for controlling contact information in an electronic communication device in which
a target party prepares the contact information concerning itself and sends it to a caller party,
the caller party receives the contact information concerning the target party and stores it to the device in order to communicate with the said target party defined by the contact information,
characterized in that the contact information concerning the target party and stored on the device of the said caller party is controlled by the said target party.
